(19) United States
(12) Patent Application Publication
(10) Pub. No.: US 2006/0289402 A1
(43) Pub. Date: Dec. 28, 2006

(54) Steel wire rod excellent in wire-drawability and fatigue property, and production method thereof

(75) Inventors: Sei Kimura, Kakogawa-shi (JP); Hisashi Yamana, Takasago-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/405,429

(22) Filed: Apr. 18, 2006

(30) Foreign Application Priority Data
Jun. 23, 2005 (JP) 2005-183414

(51) Int. Cl. B23K 9/00; B23K 9/02

(52) U.S. Cl. 219/121.44

(57) ABSTRACT

Disclosed is a steel wire rod is a steel wire rod, wherein the number of inclusions per 100 mm² in a cross section including the axis of the steel wire rod is five or less: the inclusions contained therein being oxide inclusions 5 μm or more in width in the direction perpendicular to the rolling direction; and the composition thereof satisfying the expression MgO+MnO≦30% (mass %, the same is applied hereunder) when Al₂O₃+MgO+CaO+SiO₂+MnO is defined as 100% and also satisfying either the following expression (A) or (B) when Al₂O₃+CaO+SiO₂ is defined as 100%, (A): SiO₂≧75%, and (B): Al₂O₃≧35%, SiO₂≧10%, and CaO≧10%. By reducing hard inclusions in the steel wire rod to a minimum as stated above, excellent wire-drawabil.ity and fatigue property are obtained.

### BACKGROUND OF THE INVENTION

1. Field of the Invention

The present invention relates to: a steel wire rod, in particular a steel wire rod for a high-strength extra-fine steel wire such as a steel wire rod for tire cord, a steel wire rod for a spring or the like, wherein nonmetallic inclusions are reduced to a minimum and wire-drawability and fatigue property are improved; and a method for producing the steel wire rod.

2. Description of the Related Art

When hard nonmetallic inclusions (particularly oxide inclusions) of poor ductility exist in a steel wire rod, the inclusions cause the steel wire rod to break during a wire drawing process. Further, in the case of a steel for a spring, the product undergoes cyclic stress and hence the existence of hard inclusions may cause fatigue fracture. In consequence, to improve ductility and render such nonmetallic inclusions harmless by reducing to a minimum or softening the nonmetallic inclusions are very important requirements for the production of a steel wire rod for tire cord or a steel wire rod for a spring.

From the viewpoint of attempting to soften and render ductility to nonmetallic inclusions in a steel wire rod, various technologies have heretofore been proposed. For example, JP-B Nos. 74484/1994 and 74485/1994 disclose a technology of attempting to soften and render ductility to such inclusions by controlling the composition itself of nonmetallic inclusions in a steel in a certain range.

However, the technology does not disclose a concrete means for controlling the composition of inclusions in a range wherein the inclusions are rendered ductility.

Meanwhile, JP-B No. 103416/1995, JP-A Nos. 212237/1994 and 316631/1995, and “Inclusion Control and High Purity Steel Production Technology” (the 182^{nd} and 183^{rd} Nishiyama Memorial Technical Lecture, edited by the Iron and Steel Institute of Japan, 2004, p.133-134) disclose that it is attempted to soften and render ductility to inclusions by means of controlling a slag composition in a certain range during molten steel refining.

However, in actual production processes, it is virtually impossible to render all nonmetallic inclusions in a steel ductility and control them so as to be soft. Further, it can hardly be said that the change of an inclusion composition in a steel after subjected to heating, break down rolling, and wire drawing from a cast steel produced by casting molten steel already refined is taken into consideration.

With regard to a heating temperature before rolling a cast steel, the matter is disclosed in, for example, JP-A No. 272119/1992, U.S. Pat. No. 5415711 and others, but there is no particular matter that describes a rate of temperature rise at the heating. Nevertheless, a rate of temperature rise of a cast steel at hot rolling largely affects the amount of hard inclusions such as SiO₂ (silica), CaO.Al₂O₃.SiO₂ (anorthite) and others and it sometimes happens that the frequency of breakage increases and fatigue property deteriorates if heat treating conditions are inappropriate.

### SUMMARY OF THE INVENTION

The present invention has been established under such situations and an object thereof is to provide: a steel wire rod wherein wire-drawability and fatigue property are improved more than ever when the steel wire rod is subjected to subsequent wire drawing by reducing hard inclusions in the steel wire rod to a minimum; and a method useful for producing such a steel wire rod.

A steel wire rod according to one aspect of the present invention which addresses the object is directed to a steel wire rod, wherein the number of inclusions per 100 mm² in a cross section including the axis of the steel wire rod is five or less: the inclusions contained in the steel wire rod being oxide inclusions 5 μm or more in width in the direction perpendicular to the rolling direction; and the composition thereof satisfying the expression MgO+MnO≦30% (mass %, the same is applied hereunder) when Al₂O₃+MgO+CaO+SiO₂+MnO is defined as 100% and also satisfying either the following expression (A) or (B) when Al₂O₃+CaO+SiO₂ is defined as 100%,
SiO₂≧75%, and (A)
Al₂O₃≧35%, SiO₂≧10%, and CaO≧10%. (B)

A chemical composition of a steel wire rod according to the present invention is not particularly limited as long as the steel wire rod is one that can be used for tire cord, a spring and the like. However, as a preferable steel wire rod for example, a steel wire rod containing C: 0.4 to 1.3% (mass %, the same is applied hereunder), Si: 0.1 to 2.5%, Mn: 0.2 to 1.0%, and Al: 0.003% or less (excluding 0%) is cited. Further, such a steel wire rod may further contain (a) Ni: 0.01 to 1%, (b) Cu: 0.01 to 1%, (c) Cr: 0.01 to 1.5%, (d) one or more kinds of elements selected from among the group of Li: 0.02 to 20 ppm, Na: 0.02 to 20 ppm, Ce: 3 to 100 ppm, and La: 3 to 100 ppm, and others.

In the event of producing such a steel wire rod as stated above, the operation may be carried out so that, when a cast steel to be subjected to hot rolling to produce the steel wire rod is heated, the operation time of raising the temperature of the cast steel from 1,000° C. to 1,100° C. may be 60 minutes or less.

The aspect of the present invention makes it possible to realize a steel wire rod excellent in wire-drawability and fatigue property by reducing hard oxide inclusions to a minimum, the hard oxide inclusions having a specific chemical composition and presumably affecting properties.

### BRIEF DESCRIPTION OF THE DRAWINGS

FIG. 1 is a phase diagram of CaO—SiO₂—Al₂O₃ ternary system showing an appropriate composition distribution range of inclusions.

FIG. 2 is a graph showing change in temperature with time at positions of a cast steel when the rate of temperature rise is high.

FIG. 3 is a graph showing change in temperature with time at positions of a cast steel when the rate of temperature rise is low.

FIG. 4 is a graph showing the relationship between time required for temperature rise and the number of inclusions.

FIG. 5 is a graph showing the relationship between the number of inclusions and the frequency of wire breakage.

FIG. 6 is a graph showing the relationship between the number of inclusions and a breakage percentage.

### BEST MODE FOR CARRYING OUT THE INVENTION

It is known that, by processing molten steel with slag of an appropriate composition, inclusions in a cast steel or a slab have a composition in the vicinity of the region S shown in FIG. 1 (phase diagram of CaO—SiO₂—Al₂O₃ ternary system), and soften and are ready to be rolled easily at the time of hot rolling or wire drawing (refer to the aforementioned document “Inclusion Control and High Purity Steel Production Technology”). The above region S, to be more precise, represents the region of SiO₂: 20 to 70%, CaO: 10 to 60%, and Al₂O₃: 10 to 30%.

In actual production processes however, it is virtually impossible to control nonmetallic inclusions in a steel so as to have ductility and soften. In view of the above situations, in the present invention, attention has been focused on hard inclusions of non-ductility and studies have been carried out from the viewpoint of clarifying the amount of the hard inclusions to be reduced.

In the meantime, a cast steel is heated to about 1,200° C. to 1,300° C. before it is hot rolled. If the heating treatment is inappropriate, the composition of inclusions in the cast steel changes into a composition in the vicinity of the region A, B or C shown in FIG. 1 after the heating treatment even though the composition of the inclusions in the cast steel is controlled in an appropriate range (the aforementioned range S). In particular, the inclusions having a composition in the vicinity of the region A or B are hard and are hardly elongated at the time of hot rolling or wire drawing.

The region A represents the region of a composition which satisfies the expression MgO+MnO≦30% when Al₂O₃+MgO+CaO+SiO₂+MnO is defined as 100% and also satisfies the expression SiO₂≧75% when Al₂O₃+CaO+SiO₂ is defined as 100%. Further, the region B represents the region of a composition which satisfies the expressions Al₂O₃≧35%, SiO₂≧10%, and CaO≧10% when Al₂O₃+CaO+SiO₂ is defined as 100%.

The reason why the composition of inclusions which are involved in the present invention is regulated so as to satisfy the expression MgO+MnO≦30% is that, when MgO+MnO exceeds 30%, the inclusions soften even though the expression SiO₂≧75%, or the expressions Al₂O₃≧35%, SiO₂≧10%, and CaO≧10% is/are satisfied when Al₂O₃+CaO+SiO₂ is defined as 100%.

The present inventors carried out experiments wherein cast steels containing inclusions the compositions of which were controlled in the vicinity of the aforementioned region S were used and the heating rate was changed by changing the flow rate of combustion gas supplied to each of combustion burners disposed at several places in a reheating furnace and the influence thereof was examined. As a result, the present inventors found that the degree of change in the composition of inclusions in steel wire rods after hot rolled varied in accordance with the level of the heating rate.

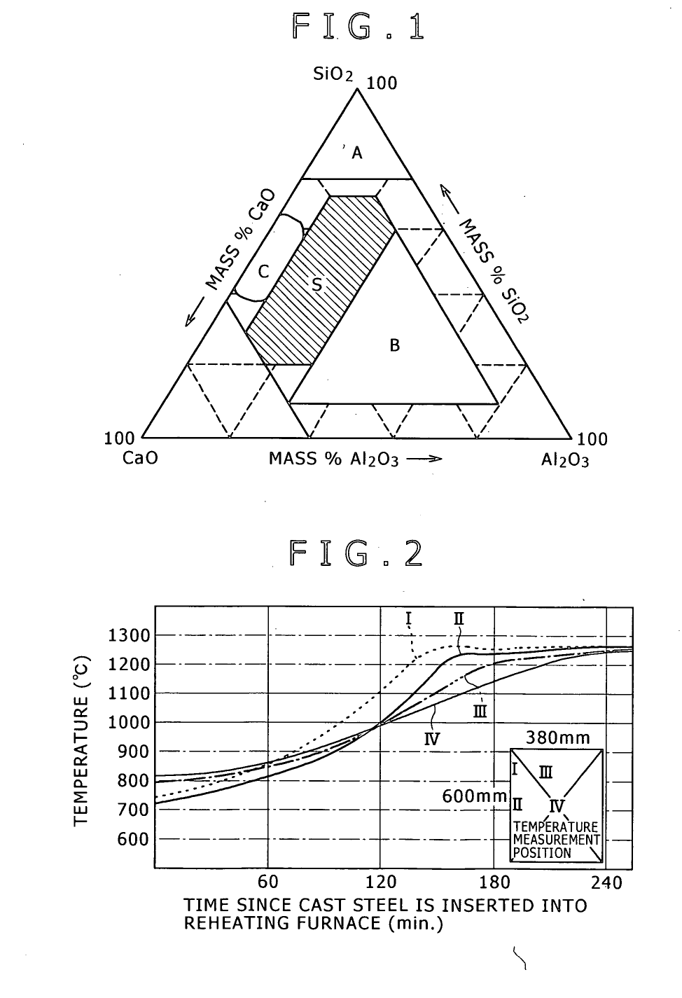

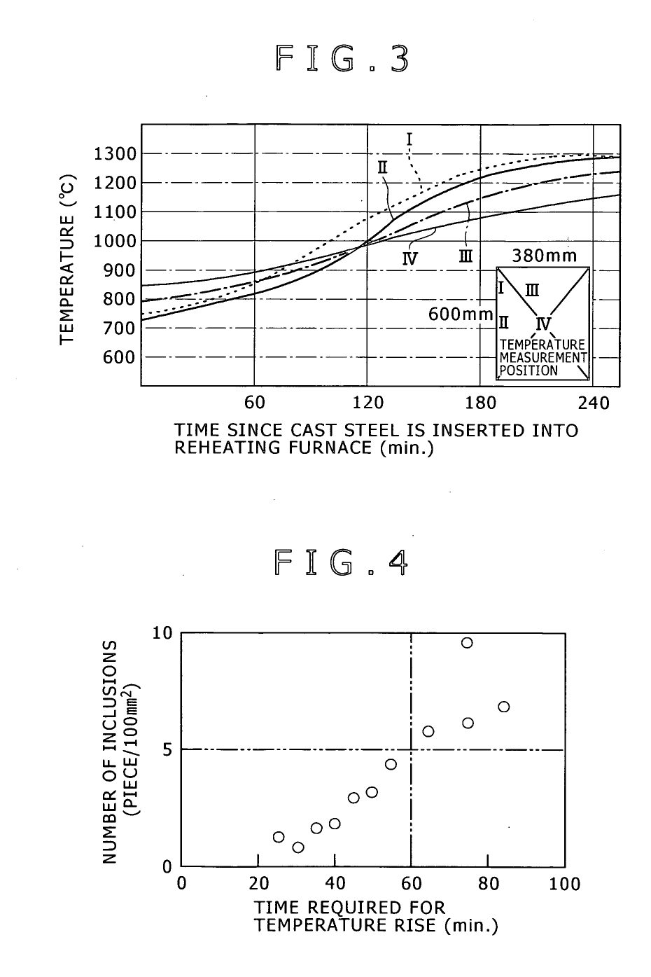

In the experiments, thermocouples were embedded into four positions in the inside of a cast steel and temperature rise at each position was measured. The position of the lowest rate of temperature rise was the position in the center of the cast steel. Changes in temperature with time at positions of cast steels are shown in FIGS. 2 and 3. Here, FIG. 2 shows the case where the rate of temperature rise is high and FIG. 3 shows the case where the rate of temperature rise is low. Further, I to IV show the positions at the cross section (600 mm×380 mm) of a cast steel where temperatures were measured.

The present inventors further carried out studies on the basis of the above experiments and found that, when the rate of temperature rise was high as shown in FIG. 2 (in particular, the time during which the temperature rose from 1,000° C. to 1,100° C. was short), the inclusions having a composition in the vicinity of the region A or B reduced. In contrast, it was found that, when the rate of temperature rise was low as shown in FIG. 3 (in particular, the time during which the temperature rose from 1,000° C. to 1,100° C. was long), the inclusions having a composition in the vicinity of the region A or B increased. At the temperature measurement position IV (the center position of the cast steel) where the temperature rise was slowest in particular, when the time during which the temperature rose from 1,000° C. to 1,100° C. was not longer than 60 minutes, the inclusions having a composition in the vicinity of the region A or B reduced.

The reason why the inclusions which are involved in the present invention are stipulated that “the width in the direction perpendicular to the rolling direction is 5 Mm or more” is that the fine inclusions less than 5 μm in width hardly act as the origins of breakage during wire drawing and fatigue fracture and do not considerably influence the wire-drawability and fatigue property. Further, the present invention involves oxide inclusions and the reason is that the sulfide inclusions are very soft, thus elongate and fine at hot rolling, and hence less influence the wire-drawability and fatigue property.

FIG. 4 is a graph showing the relationship between time required for temperature rise from 1,000° C. to 1,100° C. (temperature rise required time) at the center position (the aforementioned position IV) of a cast steel having the cross section of 600 mm×380 mm and the number of inclusions (inclusions 5 μm or more in width having the composition A or B in a 5.5 mmφ steel wire rod). As it is obvious from the result, the number of inclusions decreases as the temperature rise required time shortens, and it is understood that, when the temperature rise required time is not longer than 60 minutes in particular, it is possible to decrease the number of inclusions to not more than five per 100 mm².

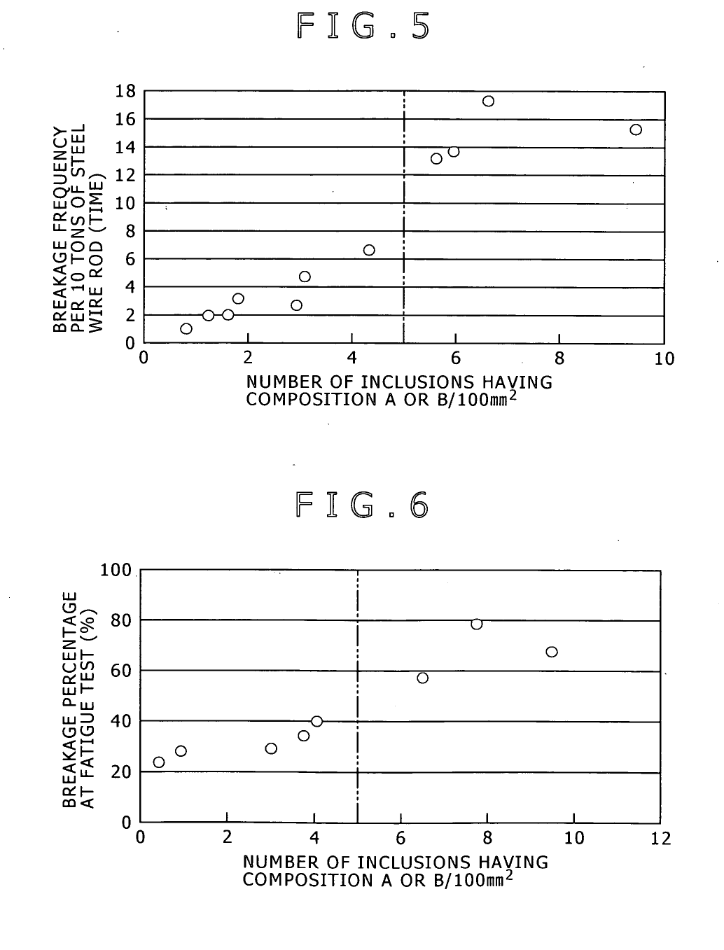

FIG. 5 is a graph showing the relationship between the number of inclusions (inclusions having the composition A or B) and the frequency of wire breakage (the frequency of wire breakage per 10 tons of steel wire rods when wire rods 5.5 mm in diameter are drawn into wires 0.2 mm in diameter). As it is obvious from the result, the frequency of wire breakage decreases as the number of inclusions having the composition A or B decreases, and it is understood that, when the number of inclusions is not more than five per 100 mm² in particular, it is possible to decrease the frequency of wire breakage to the extent of not causing problems in actual operations (not more than 7 breaks per 10 tons of steel wire rods).

FIG. 6 is a graph showing the relationship between the number of inclusions (inclusions having the composition A or B) and a breakage percentage at fatigue tests (breakage percentage of 4.8 mmφ wire rods subjected to a Nakamura-type rotating-bending fatigue test). As it is obvious from the result, it is understood that the fatigue property improves as the number of the inclusions having the composition A or B decreases.

Further, as it is obvious from the results, it is preferable to decrease the number of inclusions to a minimum (four or less, preferably three or less, per 100 mm² of a steel wire rod) in order to improve wire-drawability and fatigue property, and to do so it is important to control the time required when a cast steel is heated from 1,000° C. to 1,100° C. so as to be as short as possible.

The present invention is aimed at improving wire-drawability and fatigue property by decreasing the number of oxide inclusions having a prescribed component composition (the composition A or B) and does not limit the components of the involved steel wire rod, and a steel material generally used for wire drawing such as a steel for steel cord is used. With regard to C, Si, Mn and Al which are the basic components of such a steel material, it is preferable to stipulate the ranges of the components as described below.
C: 0.4 to 1.3%

C is an element useful for enhancing strength and, in order to exhibit such an effect, it is preferable to contain C by 0.4% or more. However, when a C content is excessive, a steel embrittles and wire-drawability is hindered. Hence it is preferable to contain C by 1.3% or less. Here, a yet preferable lower limit of a C content is 0.5% and a yet preferable upper limit thereof is 1.2%.
Si: 0.1 to 2.5%.

Si is an element having a deoxidation function and, in order to exhibit such a function, it is preferable to contain Si by 0.1% or more, yet preferably 0.5% or more. However, when a Si content is excessive, the amount of SiO₂ formed as a deoxidation product increases excessively, wire-drawability is hindered, and hence it is preferable to control a Si content to 2.5% or less, yet preferably 2.3% or less.
Mn: 0.2 to 1.0%

Mn is an element having a deoxidation function like Si and also an inclusion control function. In order to effectively exhibit those functions, it is preferable to contain Mn by 0.2% or more, yet preferably 0.3% or more. However, when a Mn content is excessive, a steel material embrittles and wire-drawability is hindered, and hence it is preferable to control a Mn content to 1.0% or less, yet preferably 0.9% or less.
Al: 0.003% or less (excluding 0%)

Al is an element very important for controlling inclusions and an Al content of about 0.001% or more in mass concentration is necessary. However, when an Al content increases, the concentration of Al₂O₃ in inclusions increases and there is a possibility of forming coarse Al₂O₃ which causes wire breakage, and hence it is preferable that an Al content is 0.003% or less.

The balance of the above basic components is composed of Fe and unavoidable impurities. If required however, it is also preferable to contain (a) Ni: 0.01 to 1%, (b) Cu: 0.01 to 1%, (c) Cr: 0.01 to 1.5%, (d) one or more kinds of elements selected from among the group of Li: 0.02 to 20 ppm, Na: 0.02 to 20 ppm, Ce: 3 to 100 ppm, and La: 3 to 100 ppm, and others. The reasons for limiting the ranges of the components when they are contained are as follows.
Ni: 0.01 to 1%

Ni does not contribute much to the increase of the strength of a steel wire but is an element useful for enhancing the toughness of a drawn wire rod. In order to exhibit the effects and functions, it is preferable to contain Ni by 0.01% or more. However, when a Ni content is excessive, the effects are saturated, and hence it is preferable that a Ni content is 1% or less. Here, a yet preferable lower limit of a Ni content when Ni is contained is 0.02% and a yet preferable upper limit thereof is 0.9%.
Cu: 0.01 to 1%

Cu is an element which contributes to a higher strength of a steel wire by the precipitation hardening function. In order to exhibit the effect, it is preferable that Cu is contained by 0.01% or more. However, when a Cu content is excessive, Cu segregates at grain boundaries and causes cracks and defects of a steel material during a hot rolling process, and hence it is preferable to control a Cu content to 1% or less. Here, a yet preferable lower limit of a Cu content when Cu is contained is 0.02% and a yet preferable upper limit thereof is 0.9%.
Cr: 0.01 to 1.5%

Cr exhibits the effect of increasing a work hardening ratio during wire drawing and makes it easier to obtain a high strength even at a comparatively low reduction ratio. Further, Cr has the function of improving corrosion resistance of a steel and is effective also in suppressing the corrosion of a fine wire steel as a rubber reinforcing material of a tire or the like. In order to exhibit those effects, it is preferable that a Cr content is 0.01% or more, yet preferably 0.02% or more. However, when Cr is contained excessively, hardenability to pearlite transformation increases, patenting treatment is hardly applied, further secondary scale becomes excessively dense, and the mechanical descaling performance and pickling performance deteriorate. Hence it is preferable that a Cr content is 1.5% or less, yet preferably 1.4% or less. One or more kinds of elements selected from among the group of Li: 0.02 to 20 ppm, Na: 0.02 to 20 ppm, Ce: 3 to 100 ppm, and La: 3 to 100 ppm

Those elements are effective for softening inclusions in a steel. In order to exhibit the effect, it is preferable to contain Li and Na by 0.02 ppm or more and Ce and La by 3 ppm or more. However, the effect is rather saturated when the contents of the elements are excessive and hence it is preferable to control Li and Na to 20 ppm or less and Ce and La to 100 ppm or less. Here, yet preferable lower limits of the elements are Li: 0.03 ppm. Na: 0.03 ppm, Ce: 5 ppm, and La: 5 ppm, respectively, and yet preferable upper limits of the elements are Li: 10 ppm. Na: 10 ppm, Ce: 80 ppm, and La: 80 ppm, respectively.

The present invention is hereunder explained further in detail on the basis of examples. However, the general nature of the after-mentioned examples is not such a thing as to limit the present invention, and all modifications in design conforming to the aforementioned and after-mentioned tenor of the present invention are included in the technological scope of the present invention.

### EXAMPLES

Each of various kinds of hot metal in the amount of 240 tons each, the hot metal being prepared by lowering the concentrations of P and S in the ranges 0.007 to 0.020% and 0.004 to 0.015% respectively in a hot metal pretreatment process (with regard to other components, refer to Tables 1 and 3 below), was charged into a basic oxygen furnace, subjected to decarburization blowing to a prescribed concentration, thereafter tapped into a ladle, and processed in a heating-type ladle refining apparatus for component adjustment and slag refining.

Successively, each of the products was cast into a cast steel 600 mm×380 mm in cross section through continuous casting. The cast steel was heated to 1,260° C., subjected to break down rolling to the cross section of 155 mm square, and further hot-rolled to produce a wire rod 5.5 mm or 8.0 mm in diameter.

All of a cross sectional plane including the axis of the wire rod was observed with an EPMA (electron probe microanalyzer) and, with regard to oxygen system inclusions 5 μm or more in width, the number of inclusions, the composition of which satisfied the expression MgO+MnO≦30% (mass %, the same was applied hereunder) when Al₂O₃+MgO+CaO+SiO₂+MnO was defined as 100% and also satisfied either the following expression (A) or (B) when Al₂O₃+CaO+SiO₂ was defined as 100%,
SiO₂≧75%, and (A)
Al₂O₃≧35%, SiO₂≧10%, and CaO≧10%, (B)
was measured and converted into the number of inclusions per 100 mm² in a cross section of the wire rod.

### Example 1

With regard to wire rods (5.5 mmφ) produced as stated above, wire-drawability as a steel wire rod for tire cord was evaluated by the following method.

(Evaluation Method)

The frequency of breakage when a wire rod was drawn from 5.5 mmφ to 0.2 mmφ was evaluated.

(Wire Drawing Method)

A steel wire rod 5.5 mm in diameter was pickled with hydrochloric acid to descale, and thereafter subjected to dry drawing up to the diameter of 1.2 mm with a continuous wiredrawing machine (Type DC-610-7BD610, made by Showa Machine Works, Ltd.). The diameters of the drawing dies used during the course of the wire drawing process were 4.8, 4.2, 3.7, 3.26, 2.85, 2.5, 2.2, 1.93, 1.69, 1.48, and 1.3 mm, and the wire drawing speed at the wire drawing in the diameter of 1.2 mm was 400 m/min.

In this case, zinc phosphate treatment was applied on the surface of the wire rod beforehand and a substance mainly composed of sodium stearate was used as the lubricant.

The wire rod drawn up to the diameter of 1.2 mm was heated to 1,230K, thereafter subjected to patenting treatment in a lead bath of 830K to form a fine pearlite structure, and then plated with brass (film thickness: about 1.5 μm) containing Cu and Zn in the ratio of 7 to 3 (mass ratio). Finally, the wire rod was drawn up to the diameter of 0.2 mm with a wet-type wiredrawing machine (Type KPZIII/25-SPZ250, made by Koch, Ernst & Co., Ltd.).

In the dipping bath in which the wire drawing was applied, a solution made up by mixing natural fatty acid containing 75% water, amino acid, and a surface-active agent was used. The diameters of the dies used during the course of the wire drawing process were 1.176, 0.959, 0.880, 0.806, 0.741, 0.680, 0.625, 0.574, 0.527, 0.484, 0.444, 0.374, 0.343, 0.313, 0.287, 0.260, 0.237, and 0.216 mm, and the wire drawing speed at the wire drawing in the diameter of 0.2 mm was 500 m/min.

The chemical compositions of the steel wire rods used here are shown in Table 1 below, and the evaluation results of the wire-drawability, together with the number of inclusions and the temperature rise required time, are shown in Table 2 below. Here, the temperature rise required time T (min.) in Table 2 represents the time required for raising the temperature from 1,000° C. to 1,100° C. at the center position of a cast steel (refer to aforementioned FIGS. 2 and 3). Note that the change of the temperature of a cast steel was measured by embedding thermocouples into the inside of the cast steel.

TABLE 1

| Test | Chemical composition (mass %) | | | | | | | | | | |
|---|---|---|---|---|---|---|---|---|---|---|---|
| No. | C | Si | Mn | Al | Ni | Cu | Cr | Li(ppm) | Na(ppm) | Ce(ppm) | La(ppm) |
| 1 | 0.71 | 0.22 | 0.45 | 0.000 | 0.00 | 0.00 | 0.00 | 0.00 | 0.00 | 0 | 0 |
| 2 | 0.73 | 0.21 | 0.48 | 0.002 | 0.00 | 0.00 | 0.00 | 0.00 | 0.00 | 27 | 0 |
| 3 | 0.78 | 0.35 | 0.52 | 0.001 | 0.00 | 0.00 | 0.00 | 0.00 | 0.00 | 0 | 0 |
| 4 | 0.80 | 0.18 | 0.52 | 0.002 | 0.00 | 0.00 | 0.00 | 0.00 | 0.00 | 15 | 24 |
| 5 | 0.81 | 0.19 | 0.55 | 0.003 | 0.25 | 0.31 | 0.43 | 15.45 | 0.00 | 0 | 0 |
| 6 | 0.83 | 0.22 | 0.61 | 0.001 | 0.00 | 0.62 | 0.00 | 0.00 | 0.00 | 68 | 0 |
| 7 | 1.05 | 0.25 | 0.58 | 0.001 | 0.55 | 0.00 | 0.65 | 0.03 | 0.00 | 0 | 0 |
| 8 | 0.97 | 0.23 | 0.56 | 0.002 | 0.92 | 0.84 | 1.37 | 1.87 | 0.06 | 13 | 37 |
| 9 | 0.88 | 0.34 | 0.47 | 0.003 | 0.00 | 0.00 | 0.00 | 0.02 | 8.40 | 0 | 0 |
| 10 | 0.82 | 0.24 | 0.49 | 0.002 | 0.00 | 0.00 | 0.00 | 0.00 | 0.00 | 0 | 0 |
| 11 | 0.77 | 0.24 | 0.63 | 0.001 | 0.00 | 0.50 | 0.00 | 0.00 | 0.00 | 32 | 55 |
| 12 | 0.72 | 0.31 | 0.42 | 0.001 | 0.00 | 0.00 | 0.00 | 0.00 | 0.00 | 0 | 0 |
| 13 | 0.77 | 0.20 | 0.63 | 0.002 | 0.00 | 0.65 | 1.41 | 0.00 | 0.00 | 26 | 0 |
| 14 | 0.82 | 0.15 | 0.63 | 0.001 | 0.00 | 0.00 | 0.00 | 0.00 | 0.00 | 0 | 0 |
| 15 | 0.97 | 0.30 | 0.60 | 0.001 | 0.51 | 0.00 | 0.67 | 0.00 | 0.00 | 0 | 0 |

TABLE 2

| | | | | | Breakage |
|---|---|---|---|---|---|
| | Temperature | Number of inclusions in 5.5 mmφ | | | frequency |
| | rise | steel wire rod (per 100 mm² in | | | per 10 tons |
| | required | cross section including axis) | | | of steel |
| Test | time T | Composition | Composition | | wire rod |
| No. | (min.) | A | B | A + B | (time) |
| 1 | 55 | 0.6 | 3.7 | 4.3 | 6.5 |
| 2 | 30 | 0.5 | 0.3 | 0.8 | 1.0 |
| 3 | 40 | 1.3 | 0.5 | 1.8 | 3.0 |
| 4 | 50 | 3.0 | 0.1 | 3.1 | 4.5 |
| 5 | 25 | 0.0 | 1.2 | 1.2 | 2.0 |
| 6 | 45 | 0.7 | 2.2 | 2.9 | 2.5 |
| 7 | 35 | 0.8 | 0.8 | 1.6 | 2.0 |
| 8 | 45 | 0.9 | 1.7 | 2.6 | 3.3 |
| 9 | 50 | 0.8 | 2.8 | 3.6 | 4.3 |
| 10 | 60 | 0.0 | 4.7 | 4.7 | 8.6 |
| 11 | 75 | 5.5 | 0.5 | 6.5 | 13.7 |
| 12 | 65 | 1.8 | 3.9 | 6.4 | 13.1 |
| 13 | 80 | 5.5 | 0.5 | 6.8 | 13.7 |
| 14 | 85 | 6.7 | 0.0 | 7.7 | 17.1 |
| 15 | 75 | 0.0 | 9.5 | 9.5 | 15.3 |

As it is obvious from the results, it is understood that, in each of the cases where the requirements stipulated in the present invention are satisfied (Test Nos. 1 to 10), the number of the inclusions having a prescribed composition decreases and good wire-drawability is obtained. In contrast, it is understood that, in each of the cases where any of the requirements stipulated in the present invention is not satisfied (Test Nos. 11 to 15), the number of the inclusions having a prescribed composition increases and the wire-drawability deteriorates.

### Example 2

With regard to the wire rods (8.0 mmφ) produced as stated above, the fatigue property as a steel wire rod for a spring was evaluated by the following method.

[Evaluation Method]

A steel wire rod 8.0 mm in diameter was subjected to Nakamura-type rotating-bending fatigue test.

[Treatment Method]

A steel wire rod 8.0 mm in diameter was subjected sequentially to oil tempering, stress relieving, shot peening, and secondary stress relief annealing, and thereafter the breakage percentage was evaluated with a Nakamura-type rotating-bending fatigue test.

[Fatigue Test Conditions]

The test was applied under the conditions of test piece length: 650 mm, number of test pieces: 30, test load: 95.8 kgf/mm² (940 MPa), rotating speed: 4,500 rpm, and frequency of test stop: 2×10⁷ times, and a breakage percentage for the broken test pieces was determined with the following expression;
Breakage percentage=(number of broken test pieces/number of all test pieces)×100 (%).

The chemical compositions of the steel wire rods used here are shown Table 3 below and the evaluation results of the fatigue property, together with the number of inclusions and the temperature rise required time (T), are shown in Table 4 below.

TABLE 3

| Test | Chemical component composition (mass %) | | | | | | | | | | |
|---|---|---|---|---|---|---|---|---|---|---|---|
| No. | C | Si | Mn | Al | Ni | Cu | Cr | Li(ppm) | Na(ppm) | Ce(ppm) | La(ppm) |
| 16 | 0.58 | 1.45 | 0.55 | 0.002 | 0.00 | 0.00 | 0.00 | 0.00 | 0.00 | 0 | 0 |
| 17 | 0.62 | 1.85 | 0.85 | 0.002 | 0.00 | 0.00 | 0.00 | 0.00 | 0.00 | 0 | 0 |
| 18 | 0.67 | 1.93 | 0.77 | 0.001 | 0.00 | 0.00 | 0.00 | 0.19 | 0.00 | 0 | 0 |
| 19 | 0.70 | 2.02 | 0.82 | 0.001 | 0.33 | 0.00 | 1.21 | 0.00 | 0.02 | 0 | 0 |
| 20 | 0.65 | 1.51 | 0.61 | 0.001 | 0.00 | 0.21 | 0.00 | 0.00 | 0.00 | 0 | 5 |
| 21 | 0.72 | 1.99 | 0.75 | 0.003 | 0.92 | 0.84 | 1.37 | 0.32 | 0.10 | 52 | 81 |
| 22 | 0.68 | 1.87 | 0.77 | 0.002 | 0.00 | 0.00 | 0.00 | 0.00 | 0.00 | 73 | 78 |
| 23 | 0.59 | 1.51 | 0.61 | 0.001 | 0.54 | 0.68 | 0.00 | 0.00 | 0.00 | 0 | 0 |
| 24 | 0.70 | 1.99 | 0.75 | 0.003 | 0.00 | 0.00 | 1.15 | 0.00 | 0.00 | 52 | 0 |
| 25 | 0.71 | 1.80 | 0.77 | 0.002 | 0.00 | 0.00 | 0.00 | 0.00 | 0.00 | 0 | 94 |
| 26 | 0.61 | 1.47 | 0.68 | 0.002 | 0.00 | 0.00 | 0.00 | 0.00 | 0.00 | 0 | 0 |
| 27 | 0.68 | 1.99 | 0.76 | 0.001 | 0.00 | 0.00 | 0.86 | 0.52 | 0.06 | 0 | 0 |
| 28 | 0.68 | 1.91 | 0.88 | 0.001 | 0.34 | 0.00 | 1.25 | 0.00 | 0.00 | 0 | 0 |
| 29 | 0.59 | 1.46 | 0.81 | 0.003 | 0.00 | 0.00 | 0.00 | 0.00 | 0.00 | 0 | 0 |
| 30 | 0.62 | 1.74 | 0.74 | 0.002 | 0.51 | 0.48 | 1.29 | 0.30 | 0.00 | 44 | 0 |

TABLE 4

| | Temperature | Number of inclusions in 5.5 mmφ | | | |
|---|---|---|---|---|---|
| | rise | steel wire rod (per 100 mm² in | | | Breakage |
| | required | cross section including axis) | | | Percentage |
| Test | time T | Composition | Composition | | at fatigue |
| No. | (min.) | A | B | A + B | test (%) |
| 16 | 45 | 0.7 | 3.1 | 3.8 | 33 |
| 17 | 25 | 0.5 | 0.5 | 1.0 | 27 |
| 18 | 35 | 0.5 | 0.0 | 0.5 | 23 |
| 19 | 55 | 4.1 | 0.0 | 4.2 | 40 |
| 20 | 40 | 2.1 | 0.7 | 2.8 | 27 |
| 21 | 50 | 4.1 | 0.0 | 4.1 | 35 |
| 22 | 60 | 4.2 | 0.3 | 4.5 | 37 |
| 23 | 30 | 2.1 | 0.0 | 2.1 | 27 |
| 24 | 40 | 4.0 | 0.0 | 3.5 | 35 |
| 25 | 55 | 3.9 | 0.6 | 4.7 | 43 |
| 26 | 65 | 5.5 | 1.1 | 6.6 | 57 |
| 27 | 75 | 9.1 | 0.5 | 9.6 | 67 |
| 28 | 85 | 5.1 | 2.8 | 7.9 | 77 |
| 29 | 70 | 2.3 | 4.7 | 7.0 | 80 |
| 30 | 80 | 1.1 | 6.7 | 7.8 | 80 |

As it is obvious from the results, it is understood that, in each of the cases where the requirements stipulated in the present invention are satisfied (Test Nos. 16 to 25), the number of the inclusions having a prescribed composition decreases and good fatigue property is obtained. In contrast, it is understood that, in each of the cases where any of the requirements stipulated in the present invention is not satisfied (Test Nos. 26 to 30), the number of the inclusions having a prescribed composition increases and the fatigue property deteriorates.

What is claimed is:

1. A steel wire rod, wherein the number of inclusions per 100 mm² in a cross section including the axis of said steel wire rod is five or less: said inclusions contained in said steel wire rod being oxide inclusions 5 μm or more in width in the direction perpendicular to the rolling direction; and the composition thereof satisfying the expression MgO+MnO≦30% (mass %, the same is applied hereunder) when Al₂O₃+MgO+CaO+SiO₂+MnO is defined as 100% and also satisfying either the following expression (A) or (B) when Al₂O₃+CaO+SiO₂ is defined as 100%,
SiO₂≧75%, and (A)
Al₂O₃≧35%, SiO₂≧10%, and CaO≧10%. (B)

2. The steel wire rod according to claim 1, containing C: 0.4 to 1.3%, Si: 0.1 to 2.5%, Mn: 0.2 to 1.0%, and Al: 0.003% or less (excluding 0%).

3. The steel wire rod according to claim 2, further containing Ni: 0.01 to 1%.

4. The steel wire rod according to claim 2, further containing Cu: 0.01 to 1%.

5. The steel wire rod according to claim 2, further containing Cr: 0.01 to 1.5%.

6. The steel wire rod according to claim 2, further containing one or more kinds of elements selected from among the group of Li: 0.02 to 20 ppm, Na: 0.02 to 20 ppm, Ce: 3 to 100 ppm, and La: 3 to 100 ppm.

7. A method for producing the steel wire rod according to claim 1, wherein, when a cast steel to be subjected to hot rolling to produce said steel wire rod is heated, the operation time of raising the temperature of said cast steel from 1,000° C. to 1,100° C. is 60 minutes or less.
